(19) United States
(12) Patent Application Publication
(10) Pub. No.: US 2008/0109732 A1
(43) Pub. Date: May 8, 2008

(54) BROWSER PAGE WITH SELECTIVELY INACTIVE CONTROLS TO SAFEGUARD AGAINST DATA ERRORS

(75) Inventors: Zeno RUMMLER, Stutensee (DE); Frank MILPETZ, Wiesloch (DE); Song-Jo CHUNG, Stutensee (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/557,357

(22) Filed: Nov. 7, 2006

(51) Int. Cl. G06F 3/00

(52) U.S. Cl. 715/738

(57) ABSTRACT

In a browser control method, a page to be rendered in a browser contains at least two elements of information content which can be rendered for the page. A first element contains content and browser controls through which the user interacts as appropriate to suit his needs. Some of the controls may be of a type that can cause data errors if they were engaged repeatedly in an attempt to communicate with a server (which might occur if, for example, server response were delayed due to traffic errors). When such controls are engaged, a second element of information content from the page may be displayed over the control to render it insensitive to subsequent attempts to engage it.

### BACKGROUND

Modern enterprises increasingly are using the Internet to transact business with business partners such as customers, suppliers and service providers. Using the Internet, a business partner at a client terminal may access enterprise services at a server. The server opens a communication portal with the client terminal in which the server delivers a series of browser-based pages (typically, HTML pages) for display on the client terminal. The business partner works through a portal session by interactively entering information via the browser, which delivers user input to the server. The server may record business transactions (such as product orders, service requests, etc.) and deliver additional browser-based pages to the client terminal until the portal session is concluded. Having captured information of the business transactions, the enterprise may process the transactions according to its own processes. In this regard, a portal-based communication session provide a convenient mechanism to automate transaction processing with a large, often geographically-distributed set of business partners.

Such communication sessions are not without their drawbacks, however. Client-server communications across the Internet are stateless and there can be appreciable latency between the time a client terminal presents new input to a server and the time a subsequent page of information is returned from the server and rendered on the client terminal's screen. Typically, a page with which an operator has interacted remains active and displayed until a new page is returned from a server. Sometimes, an operator perceives unexpected latency as a communication error and cause the client terminal to transmit user input to the server repeatedly. If, for example, an operator causes the client terminal to submit a first batch of data to a server and, before the server responds with a second page, causes the terminal to submit a second batch of data (having either the same or different content as the first batch), transaction errors can arise. A server may record multiple transactions from the multiple submissions (e.g., multiple purchases when an operator intended to make only a single purchase) or may enter an error resolution process to identify the operator's intent. Cumbersome error resolution processes can cause business partners' satisfaction to diminish.

Accordingly, there is a need in the art for a portal-based communication protocol which controls client operation and, after the browser transmits user input to a server, renders the browser insensitive to further commands until the server returns a response to the browser.

### BRIEF DESCRIPTION OF THE DRAWINGS

FIG. 1 illustrates a network system according to an embodiment of the present invention.

FIG. 2 illustrates an exemplary user interface according to an embodiment of the present invention.

FIG. 3 illustrates the user interface of FIG. 2 according to another embodiment of the present invention.

FIG. 4 illustrates an architecture of a browser page according to an embodiment of the present invention.

FIG. 5 is a flow diagram illustrating a method of operation for a client device according to an embodiment of the present invention.

### DETAILED DESCRIPTION

Embodiments of the present invention provide a browser control method in which a page to be rendered in a browser contains at least two elements of information content which can be rendered for the page. A first element contain content and browser controls through which the user interacts as appropriate to suit his needs. Some of the controls may be of a type that can cause data errors if they were engaged repeatedly in an attempt to communicate with a server (which might occur if, for example, server response were delayed due to traffic errors). According to an embodiment of the invention, when such controls are engaged, a second element of information content from the page may be displayed over the control to render it insensitive to subsequent attempts to engage it.

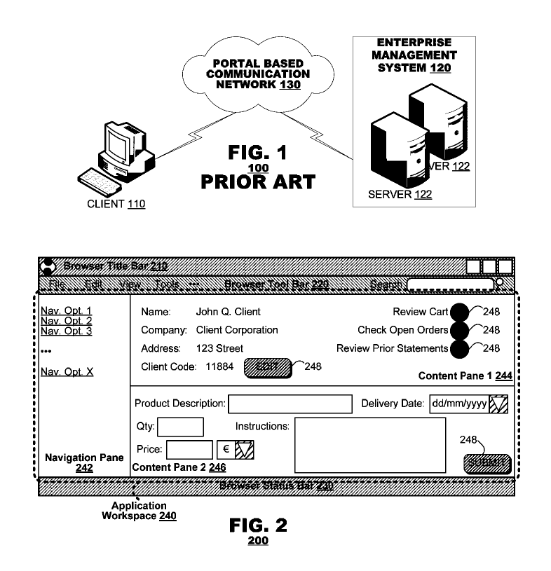

FIG. 1 is a high-level block diagram of a convention client-server system 100, suitable for use with embodiments of the present invention. The system 100, as indicated, may include one or more terminal devices 110 and an enterprise management system 120, interconnected via a communication network 130. Conventional terminal devices 110 may include personal computers, laptop computers, tablet computers, portable digital assistants, mobile phones or any other workstation on which a browser application may execute. The enterprise management system 120 may be populated by one or more servers 122 which execute transactional applications and generate pages for transmission to and display by the client terminals 110. The communication network may be the Internet, a wide area network or any other network suitable to carry the pages and user input information back and forth between the client 110 and servers 122. In this regard, the operation of a client-server system 100 is well known.

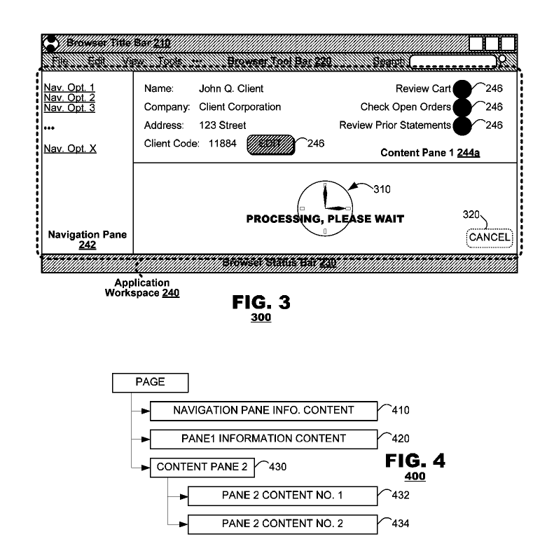

FIG. 2 illustrates an exemplary user interface 200 of a browser according to an embodiment of the present invention. There, the user interface 200 includes a browser title bar 210, one or more tool bars 220, a browser status bar 230 and an application workspace 240. The title bar 210, the tool bar(s) 220 and status bar 230 display content that is determined by a browser application that executes locally on the client terminal 110 (FIG. 1). Conventionally, the title bar 210 identifies the title of the application to distinguish it from other applications, e.g., word processing programs, spreadsheet programs, etc., that may execute on the client terminal 110. The tool bar 220 typically provides interactive tools that may control operation of the browser, e.g., to open and store pages, to bookmark network locations, etc. The browser status bar 230 may display operational status of the browser, for example, whether the client is interacting with a server or whether (and how much) of a new page has been received from a server when the client is receiving a new page of information.

The application workspace 240 typically displays information content of an application executing on a server, which is delivered to the client in a page. In the example of FIG. 2, the page is illustrated as being composed of three panes of information—a navigation pane 242 and a pair of content panes 244, 246. The navigation pane 242, as its name implies, may provide controls that permit an operator to navigate among functionality offered by the enterprise management system 120. When an operator selects an option from the navigation pane 242, the client terminal delivers a message to the server identifying the selected option, which often causes the server to deliver a new page that completely rewrites the application workspace 240.

The content panes 244a, 244b may display different forms of content of the application. In the example of FIG. 2, the first pane 244a is shown as displaying information relating to a business partner and the second pane 244b provides data entry controls to accept product orders. The first pane displays both information content and various operator controls 246, which permit the operator to query the server-side application for various pieces of information. As representative examples, the controls 246 permit an operator to edit business partner data, review content of a shopping cart, check open orders and review prior statements. As indicated previously, the information content displayed in the workspace 240 will be tailored as appropriate to the application executing on the server 122 (FIG. 1).

In the example of FIG. 2, the second pane 244b illustrates various data entry controls to permit an operator to enter data regarding a desired purchase. Thus, FIG. 2 illustrates text entry boxes and pull down menus that are appropriate to this task. A submit button 248 also is shown, which when activated causes the client to submit the user-entered information from the content pane 244b.

According to an embodiment of the present invention, select controls of a rendered page, when activated, may render the page non-responsive to additional operator input. One such embodiment is illustrated in FIG. 3. When an operator enters content in the pane 244b of FIG. 2 and clicks the submit button 248, the rendered page may obscure the control 248 with non-interactive content 310 to block further attempts to trigger the control. For example, as shown in FIG. 3, the content of pane 244b is replaced with a message indicating the request has been submitted. The prior submit button 248 (FIG. 2) is removed.

In another embodiment, the non-interactive content 310 need not be wholly non-interactive. It is sufficient for purposes of the present discussion to render as non-interactive the control 248 that represents a completed transaction to be conducted with the server. Other controls may be maintained as interactive, for example the controls of the first content pane 242a. Additionally, new controls may be included in the second content pane 242b as may be appropriate—for example, by including a cancel button 320. In such an instance, the cancel button also may cause a communication to occur with the server which repudiates the transaction that the control 248 attempted to implement. In this instance, it may be appropriate to provide the cancel button 320 as an ordinary button which remains interactive even after being triggered a first time. Oftentimes, transmitting several cancel requests does not cause data errors that could occur if several purchase requests were transmitted. Thus, the controls of the present invention may be intermingled with other types of controls that ordinarily are found on browser pages.

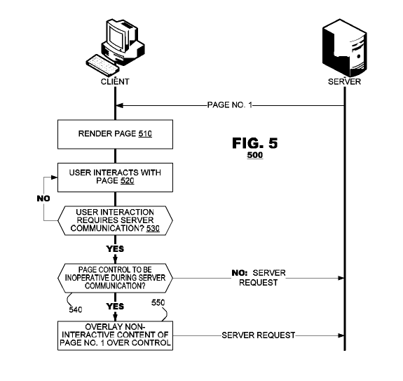

FIG. 4 illustrates an architecture of a browser page 400, according to an embodiment, as it may be delivered from a server to a client. As shown in FIG. 4, a page 400 may organize content according to a hierarchy of data elements. Working from the example of FIGS. 2 and 3, the navigation pane 410, pane1 420 and pane2 430 may occupy co-equal ranks among the hierarchy of the page. In the example of FIG. 4, these elements 410-430 are shown as immediate children of a root node. According to an embodiment, pane2 430 may have two different content items 432, 434 associated with it, which may be represented as subordinate items in the hierarchical view of FIG. 4. The first content item 432 may represent information content of the pane, such as the content shown in the example of FIG. 2. The second content item 434 may represent a second view of the pane, complete with its own information content, such as the content shown in the example of FIG. 3. Operator interaction with controls from the first content item 432 can cause a browser to over-write the content pane 430 with the second content item 434 without requiring communication with a server.

FIG. 5 is a flow diagram illustrating a method 500 of operation for a client device according to an embodiment of the present invention. The method 500 may begin when a server delivers a page to the client device (labeled “page no. 1” in FIG. 5). The client device may render the page for display using a browser application (box 510). Thereafter, the user may interact with the page in a manner at the user's discretion (box 520). Throughout this operation, the client device may determine whether the user interaction requires the client to communicate with the server, for example, by engaging a control displayed on the page (box 530). If so, the client device may determine whether the control so engaged must be rendered inoperative during server communication (box 540). If not, server communication may proceed according to normal processes. If so, however, the browser may overwrite non-interactive content over the control that was engaged (550) and transmit the server request. Thereafter, the browser page does not permit an operator to send another server request that duplicates the first, which could cause data processing errors at the server.

Although the foregoing embodiments describe operation of the invention in the context of “dummy” data, the invention is not so limited. As illustrated in FIG. 6, the second content element may illustrate data collected and transmitted to a server as part of the transaction for which the first content element was designed. Doing so, of course, permits an operator to review and double-check entered data while a transaction is being processed at a server.

The principles of the present invention may be extended to other use scenarios. In another embodiment, a page may include a number of data items provided in a common level of a page hierarchy (e.g., content no. 1 and content no. 2 432, 434 of FIG. 4). User controls within the page, when activated, may cause a browser to select and display a next content item in series without requiring communication from the browser's client to a server. This embodiment can be useful to permit an operator to browse among a large set of items (e.g., 10 items or more) in a confined area of a display and without requiring extensive communication with a server.

Further, a transition between content items in a page may be made in response to an automated process. In some applications, a connection between a client and a server may ‘time out’ if a predetermined period elapses without new activity between the client and server. In such an embodiment, a page may define a time out time period which, if reached without new interaction with the server, causes an active content element of a page to be replaced automatically with another content element to indicate termination of the communication session.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method of operation at a browser, comprising:
displaying a page at the browser that includes first information content and associated controls defined in a browser page,
responsive to user interaction with a selected control, displaying second information content from the page in a manner that renders the selected control inoperative.

2. The method of claim 1, wherein the selected control also causes the browser to transmit a request to a server.

3. The method of claim 2, wherein the second information content is displayed before the request is transmitted to the server.

4. The method of claim 1, wherein the page is a multi-pane page and the first and second information content are displayed within a common pane of the page.

5. The method of claim 1, wherein the second information content is a pseudo progress indicator

6. The method of claim 1, wherein the second information content includes a control to cancel a transaction represented by the selected control.

7. A computer readable medium storing a page to be rendered via a browser application, comprising:
a hierarchical arrangement of data elements, the data elements comprising information content and browser controls, at least one of the data elements comprising a first content element and a second content element,
the page defining that the second content element obscured a rendered portion of the first content element when a browser control contained within the first content element is triggered by user interaction, the second content element obscuring the triggered control.

8. The medium of claim 7, wherein the page also defines that the triggered control, when triggered, causes communication by the browser to a network resource.

9. The medium of claim 8, wherein the page also defines that the second element obscures the triggered control before the communication to the network resource.

10. The medium of claim 7, wherein the page defines at least two panes of information content for simultaneous rendering via the browser, the first and second content elements being displayed in one of the panes.

11. The medium of claim 7, wherein the second content element includes a control to cancel a transaction represented by the triggered control of the first content element.

12. A computer readable medium storing a page to be rendered via a browser application, comprising:
a hierarchical arrangement of data elements, the data elements comprising information content and browser controls, at least one of the data elements comprising multiple content elements at a common level of a hierarchy,
the page defining a first of the content elements to be displayed and defining a control that, when activated, causes a next content element to replace the first content element in a display.

13. The medium of claim 12, wherein the page defines at least two panes of information content for simultaneous rendering via the browser, the multiple content elements being displayed in one of the panes.

14. A method of operation at a browser, comprising:
displaying a page at the browser that includes first information content and associated controls defined in a browser page,
when a predetermined condition is met, displaying second information content from the page in a manner that renders an associated control inoperative.

15. The method of claim 14, wherein the condition is met when a timeout counter elapses.

16. The method of claim 14, wherein the condition is met when an operator interacts with the associated control.
